(19) United States
(12) Patent Application Publication
(10) Pub. No.: US 2008/0168505 A1
(43) Pub. Date: Jul. 10, 2008

(54) Information Processing Device and Method, Recording Medium, and Program

(75) Inventors: Naoki Saito, Kanagawa (JP); Yusuke Sakai, Kanagawa (JP); Mikio Kamada, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/572,593

(22) PCT Filed: Jul. 20, 2005
(86) PCT No.: PCT/JP2005/013293

§ 371 Date: Nov. 15, 2007

(30) Foreign Application Priority Data
Jul. 27, 2004 (JP) 2004-218530

(51) Int. Cl. G06F 3/00

(52) U.S. Cl. 725/61

(57) ABSTRACT

The present invention relates to an information processing apparatus and method, a recording medium, and a program which make it possible for persons at remote places to view the same content in synchronism with each other. For example, if a user A performs an operation for playback starting of a content at time t1, then a line delay when operation information is transmitted is taken into consideration to determine reproduction starting scheduled time t2, and operation information representing that an operation for playback starting is performed and also representing reproduction starting scheduled time t2 and a playback position of the content at time t2 is produced and transmitted to an user X side. Then, the user A side starts playback of the content at time t2. Also on the user X side, when the reproduction starting scheduled time t2 represented by the received operation information comes, playback of the content is started from the playback position of the content represented by the received operation information. Accordingly, after time t2, a state wherein synchronous playback of the content is performed continues. The present invention can be applied, for example, to a communication apparatus between remote places.

### TECHNICAL FIELD

This invention relates to an information processing apparatus and method, a recording medium, and a program, and particularly to an information processing apparatus which communicates sound and an image of a user with a different information processing apparatus connected thereto through a network and plays back the same content in synchronism with the different apparatus, and an information processing method, a recording medium, and a program.

### BACKGROUND ART

Conventionally, as apparatus for use for exchange between persons at remote places (such exchange is hereinafter referred to as remote communication), a telephone set, a visual telephone set, a video conference system and so forth are available. Also a method wherein a personal computer or the like is used and connected to the Internet to perform text chatting, video chatting which involves an image and sound or the like is available.

Also it has been proposed for persons who try to execute remote communication to use individual personal computers or the like to share a virtual space through the Internet or share the same content (refer to, for example, Patent Document 1).

[Patent Document 1] Japanese Patent Laid-Open No. 2003-271530

### DISCLOSURE OF INVENTION

### Problem to be Solved by the Invention

However, the conventional method wherein persons at remote places share the same content has a subject that the timings of playback of the content cannot accurately be synchronized with each other.

Accordingly, the conventional method has a subject that, while persons at remote places communicate images and sound with each other, they cannot view the same content and cannot weep, laugh, be affected or the like at the same timing.

The present invention has been made in view of such a situation as described above, and it is an object of the present invention to make it possible for persons at remote places to view the same content in synchronism with each other.

### Means for Solving the Problem

An information processing apparatus of the present invention includes a playback section configured to play back content data in response to an operation by a user, a production section configured to produce operation information corresponding to the operation by the user and transmit the operation information to a different information processing apparatus through a network, and a playback control section configured to synthesize playback of the content data by the playback section with play back of the content data by the different information processing apparatus based on operation information transmitted from the different information processing apparatus through the network.

The content data may be data broadcast as a television program.

The production section may produce, in response to an operation of changing over the channel of the television broadcast by the user, the operation information representative of a channel after the changeover.

The production section may produce the operation information which includes at least one of the substance of the operation of the user, time at which the operation is performed and a playback position of the content data.

The production section may produce the operation information which includes at least one of the substance of the operation of the user, starting scheduled time of a process corresponding to the operation and a playback position of the content data.

The information processing apparatus may further include a detection section configured to detect communication time required for communication of the operation information through the network, and the production section may determine the starting scheduled time of the process corresponding to the operation based on the communication time.

The information processing apparatus may further include a communication section configured to communicate sound and an image of the user with the different information processing apparatus through the network.

An information processing method of the present invention includes a playback step of playing back content data in response to an operation by a user, a production step of producing operation information corresponding to the operation by the user and transmitting the operation information to a different information processing apparatus through a network, and a playback control step of synthesizing playback of the content data by the process at the playback step with play back of the content data by the different information processing apparatus based on operation information transmitted from the different information processing apparatus through the network.

A program of a recording medium of the present invention includes a playback step of playing back content data in response to an operation by a user, a production step of producing operation information corresponding to the operation by the user and transmitting the operation information to a different information processing apparatus through a network, and a playback control step of synthesizing playback of the content data by the process at the playback step with play back of the content data by the different information processing apparatus based on operation information transmitted from the different information processing apparatus through the network.

A program of the present invention includes a playback step of playing back content data in response to an operation by a user, a production step of producing operation information corresponding to the operation by the user and transmitting the operation information to a different information processing apparatus through a network, and a playback control step of synthesizing playback of the content data by the process at the playback step with play back of the content data by the different information processing apparatus based on operation information transmitted from the different information processing apparatus through the network.

In the information processing apparatus and method and the programs of the present invention, operation information corresponding to an operation by a user is produced and transmitted to the different information processing apparatus through the network. Further, based on operation information transmitted from the different information processing apparatus through the network, playback of content data is synchronized with that of the different information processing apparatus.

### EFFECT OF THE INVENTION

According to the present invention, persons at remote places can view the same content in synchronism with each other.

### BRIEF DESCRIPTION OF THE DRAWINGS

FIG. 1 shows an example of a configuration of a communication system to which the present invention is applied.

FIG. 2A is a view showing an example of an image of a content and an image of a user.

FIG. 2B is a view showing an example of an image of a content and an image of a user.

FIG. 2C is a view showing an example of an image of a content and an image of a user.

FIG. 3A is a view showing an example of synthesis of an image of a content and images of users.

FIG. 3B is a view showing an example of synthesis of the image of the content and an image of a user.

FIG. 3C is a view showing an example of synthesis of the image of the content and the image of the user.

FIG. 4 is a block diagram showing an example of a configuration of a communication apparatus of FIG. 1.

FIG. 5 is a flow chart illustrating a remote communication process by the communication apparatus.

FIG. 6 is a view illustrating an outline of a synchronous content acquisition mode applied to a first synchronous playback process.

FIG. 7 is a flow chart illustrating the first synchronous playback process.

FIG. 8 is a view illustrating an outline of a following type synchronization mode applied to a second synchronous playback process.

FIG. 9 is a flow chart illustrating the second synchronous playback process.

FIG. 10 is a view illustrating an outline of a reservation type synchronization mode applied to a third synchronous playback process.

FIG. 11 is a flow chart illustrating the third synchronous playback process.

FIG. 12 is a block diagram showing an example of a configuration of a general purpose personal computer.

### DESCRIPTION OF REFERENCE NUMERALS

1 communication apparatus, 2 communication network, 3 content supplying server, 4 authentication server, 5 broadcasting apparatus, 6 standard time information supplying apparatus, 21 outputting section, 22 display unit, 23 loudspeaker, 24 inputting section, 25 camera, 26 microphone, 27 sensor, 28 communication section, 29 broadcast reception section, 30 content playback section, 31 image sound synthesis section, 32 storage section, 33 content, 34 synthesis information, 35 image analysis section, 36 mirror image production section, 37 pointer detection section, 38 motion vector detection section, 39 matching section, 40 communication environment detection section, 41 standard time counting section, 42 operation inputting section, 43 control section, 44 session management section, 45 viewing recording level setting section, 46 playback synchronization section, 47 synthesis control section, 48 playback permission section, 49 recording permission section, 50 operation information outputting section, 51 electronic apparatus control section, 100 personal computer, 101 CPU, 111 recording medium

### BEST MODE FOR CARRYING OUT THE INVENTION

In the following, a particular embodiment to which the present invention is applied is described in detail with reference to the drawings.

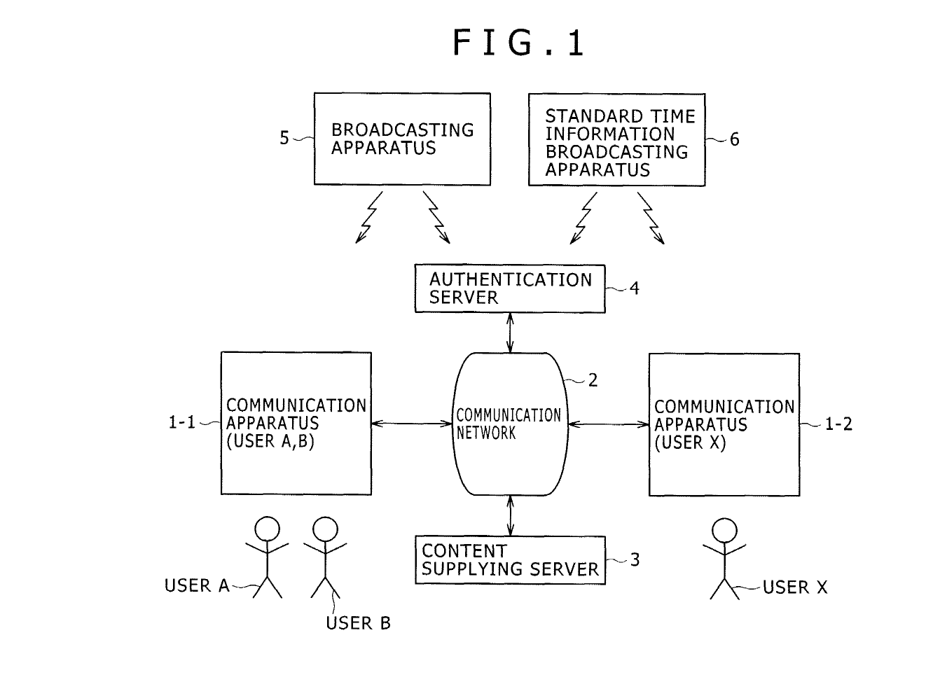

FIG. 1 shows an example of a configuration of a communication system to which the present invention is applied. In this communication system, a communication apparatus 1-1 establishes a connection to a different communication apparatus 1 (in the case of FIG. 1, a communication apparatus 1-2) through a communication network 2 to mutually communicate sound and an image of a user similarly as in the case of a visual telephone system and besides play back a common content (such as moving pictures, still pictures and so forth of, for example, a program content obtained by reception of a television broadcast or the like, a content of a movie or the like acquired by downloading or the like in advance, a private content transferred between users and so forth) in synchronism with the different communication apparatus 1-2 to support remote communication between the users. In the following description, where there is no necessity to distinguish the communication apparatus 1-1 and 1-2 from each other, each of them is referred to simply as communication apparatus 1.

Each communication apparatus 1 can be utilized simultaneously by a plurality of users. For example, in the case of FIG. 1, it is assumed that the communication apparatus 1-1 is used by users A and B while the communication apparatus 1-2 is used by a user X.

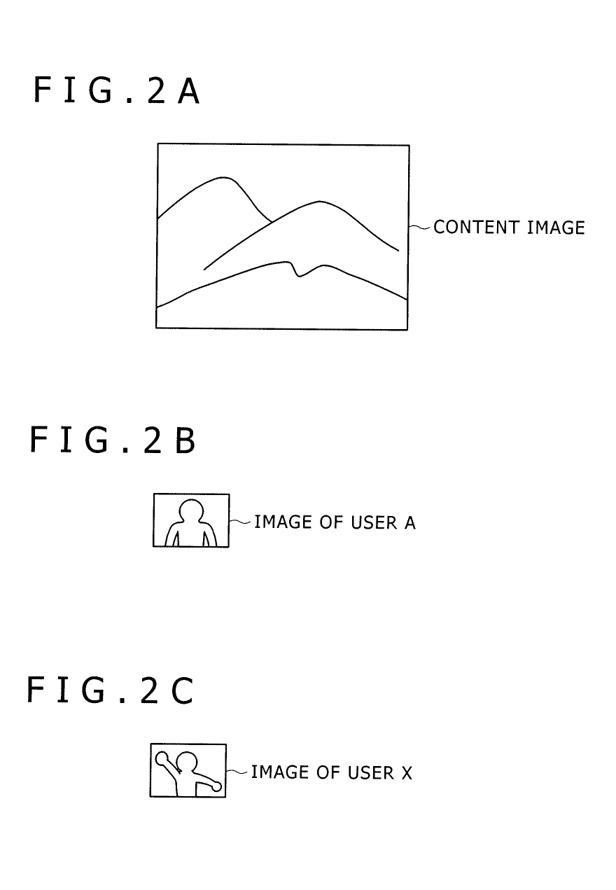

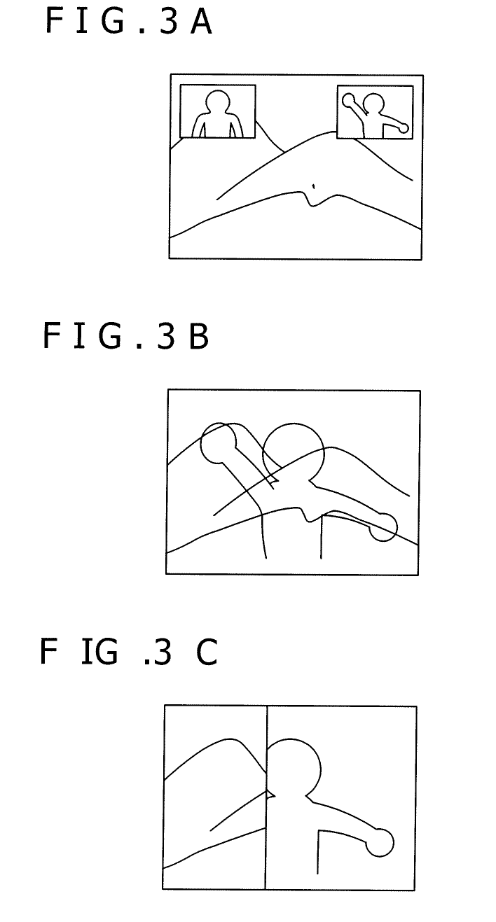

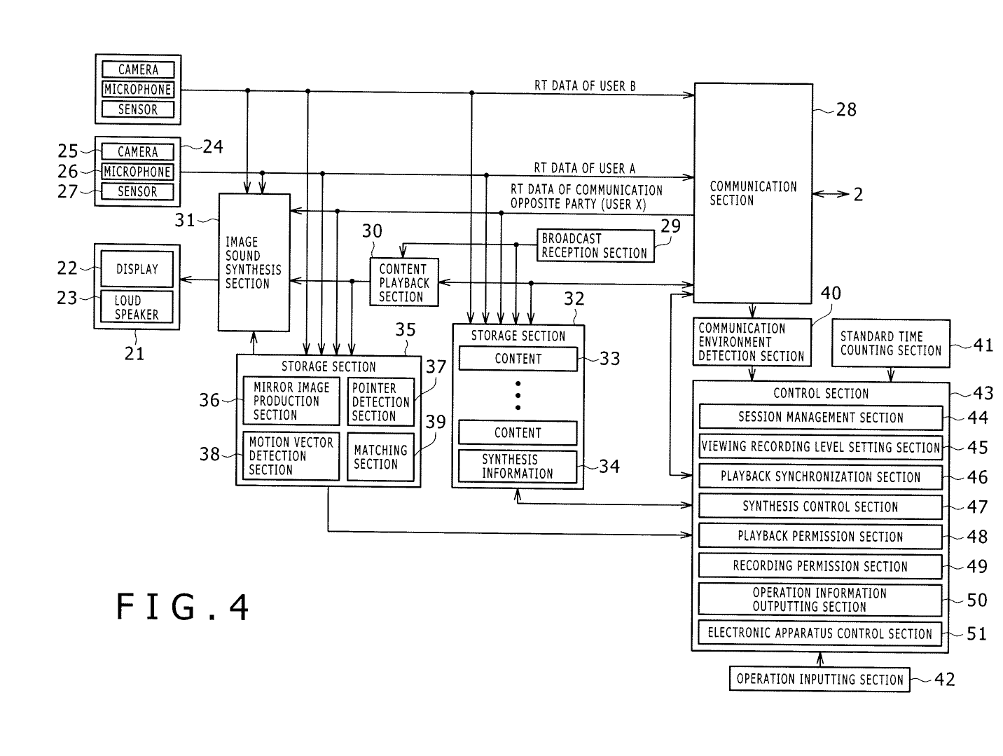

For example, it is assumed that the image of the common content is such as shown in FIG. 2A and the image of the user A picked up by the communication apparatus 1-1 is such as shown in FIG. 2B while the image of the user X picked up by the communication apparatus 1-2 is such as shown in FIG. 2C. In this instance, on a display unit 22 (FIG. 4) of the communication apparatus 1-1, the images of the content and the user are displayed in a superposed relationship in accordance with, for example, in a picture in picture (picture in picture) mode shown in FIG. 3A, a cross fade (cross fade) mode shown in FIG. 3B or a wipe (wipe) mode shown in FIG. 3C.

It is to be noted that, in the picture in picture mode shown in FIG. 3A, the images of the users are superposed as small screens on the image of the content. The display positions and sizes of the small screens can be arbitrarily changed. Also it is possible to display not both of the images of the user itself (user A) and the communication opposite party (user X) but display only one of the small screens. Further, the images may be displayed in an α blending mode such that the image of the content can be observed through the small screens of the images of the users.

In the cross fade mode shown in FIG. 3B, the image of a user (user A or user X) is displayed in an α blended manner on the image of the content. This cross fade mode can be used, for example, when the user points to an arbitrary position or region on the image of the content or in a like case.

In the wide mode shown in FIG. 3C, the image of the user appears from a predetermined direction in such a manner that it covers the image of the content.

The synthesis method of a content and images of users may be changed at any time. Further, the images of the content and the users may be displayed applying a mode different from the modes described above.

Synthesis situations of the images and the sounds of the content and the users such as, for example, the distinction among the picture in picture, cross fade and wide modes, the sizes and the positions of child pictures where the picture in picture mode is adopted, the transmission degree of the α blending where the cross face mode is adopted, the ratio in sound volume and so forth, are recorded as synthesis information 34 (FIG. 4).

Referring back to FIG. 1, the communication network 2 is a broadband data communication network represented by the Internet or the like, and a content supplying server 3 supplies a content to the communication apparatus 1 through the communication network 2 in accordance with a request from the communication apparatus 1. An authentication server 4 performs processes for authentication, accounting and so forth when the user of the communication apparatus 1 tries to utilize the communication system.

A broadcasting apparatus 5 transmits a content as a program of a television broadcast or the like. Accordingly, the individually communication apparatus 1 can receive and play back a content broadcast from the broadcasting apparatus 5 in synchronism with each other. It is to be noted that transmission of a content from the broadcasting apparatus 5 to the communication apparatus 1 may be performed by wireless transmission or by wire transmission. Or, such transmission may be performed through the communication network 2.

A standard time information supplying apparatus 6 supplies standard time information for adjusting clocks (standard time counting section 41 (FIG. 4)) built in the communication apparatus 1 to standard time (world standard time, Japan standard time or the like) to the individual communication apparatus 1. It is to be noted that the supply of standard time information from the standard time information supplying apparatus 6 to the communication apparatus 1 may be performed by wireless communication or by wire communication. Further, the supply may be performed through the communication network 2.

Now, an example of a detailed configuration of the communication apparatus 1-1 is described with reference to FIG. 4.

In the communication apparatus 1-1, an outputting section 21 is formed from a display unit 22 and a loudspeaker 23, and displays an image and outputs sound corresponding to an image signal and a sound signal inputted thereto from an image sound synthesis section 31.

An inputting section 24 includes a camera 25 for picking up an image (moving picture or still picture) of a user, a microphone 26 for collecting sound of the user, and a sensor 27 for detecting surrounding environment information (brightness, temperature, humidity and so forth) of the user. The inputting section 24 outputs real-time (RT) data of the user including the acquired moving pictures, sound and surrounding environment information to a communication section 28 and a storage section 32. The camera 25 has a function which can measure the distance to an image pickup subject (user). Further, the inputting section 24 outputs the acquired image and sound of the user to the image sound synthesis section 31. Further, the inputting section 24 outputs the acquired image to an image analysis section 35. It is to be noted that a plurality of inputting apparatus 24 (in the case of FIG. 24, two inputting apparatus 24) may be provided such that they are directed to plurality of users (users A and B of FIG. 1).

The communication section 28 transmits real-time data of the user A inputted thereto from the inputting section 24 to the communication apparatus 1-2 of the communication opposite party through the communication network 2. Further, the communication section 28 receives real-time data of the user X transmitted from the communication apparatus 1-2 and outputs the real-time data to the image sound synthesis section 31, storage section 32 and image analysis section 35. Further, the communication section 28 receives a content supplied thereto from the communication apparatus 1-2 of the communication opposite party or the content supplying server 3 through the communication network 2 and outputs the content to a content playback section 30 and the storage section 32. Furthermore, the communication section 28 transmits a content 33 stored in storage section 32 or operation information produced by an operation information outputting section 50 to the communication apparatus 1-2 through the communication network 2.

A broadcast reception section 29 receives a television broadcast signal broadcast from the broadcasting apparatus 5 and outputs an acquired content as a broadcast program to the content playback section 30. The content playback section 30 plays back the content of the broadcast program received by the broadcast reception section 29, a content received by the communication section 28 or a content read out from the storage section 32 and outputs a resulting image and sound of the content to the image sound synthesis section 31 and the image analysis section 35.

The image sound synthesis section 31 synthesizes an image of a content inputted from the content playback section 30, an image of a user and an image for OSD (On Screen Display) by a blending or the like and outputs a resulting image signal to the outputting section 21. The image sound synthesis section 31 synthesizes sound of the content inputted from the content playback section 30 and sound of a user and outputs a resulting sound signal to the outputting section 21.

The storage section 32 stores real-time data of a user (user A or the like) supplied thereto from the inputting section 24, real-time data of the communication opposite party (user X) supplied thereto from the communication section 28, a content of a broadcast program received by the broadcast reception section 29 and a content supplied thereto from the communication section 28 while periodically adding standard time supplied thereto from the standard time counting section 41 to them through a control section 43. Further, the storage section 32 stores also synthesis information 34 produced by a synthesis control section 47.

The image analysis section 35 analyzes the brightness and the luminance of an image of a content inputted thereto from the content playback section 30 and images of users (including also an image of a user supplied from the communication apparatus 1-2) and outputs a result of the analysis to the synthesis control section 47. A mirror image production section 36 of the image analysis section 35 produces a mirror image of images of the users (including an image of a user received from the communication apparatus 1-2). A pointer detection section 37 detects a wrist, a finger tip or the like which is used as a pointer by a user for pointing to a desired position from within an image of the users (including an image of a user from the communication apparatus 1-2) detected by a motion vector detection section 38 and extracts an image of the pointer. Where an image from the inputting section 24 includes a plurality of users, a plurality of pointers are detected and coordinated with the users. The motion vector detection section 38 detects a motion vector indicative of a motion of each user from an image of users (including an image of a user from the communication apparatus 1-2) and identifies a generation point and a locus of the motion vector. A matching section 39 decides with which one of motions of the user estimated in advance the detected motion vector of the user coincides, and outputs a result of the decision as motion vector matching information to the control section 43.

A communication environment detection section 40 monitors the communication environment (communication rate, communication delay time and so forth) with the communication apparatus 1-2 through the communication section 28 and the communication network 2 and outputs a result of the monitoring to the control section 43. The standard time counting section 41 adjusts the standard time counted by the standard time counting section 41 itself based on standard time information supplied thereto from the standard time information supplying apparatus 6 and supplies the standard time to the control section 43. An operation inputting section 42 is formed from, for example, a remote controller or the like and accepts an operation of a user and then inputs a corresponding operation signal to the control section 43.

The control section 43 controls the components of the communication apparatus 1-1 based on an operation signal corresponding to an operation of a user inputted from the operation inputting section 42, motion vector matching information inputted from the image analysis section 35 and so forth. The control section 43 includes a session management section 44, a viewing recording level setting section 45, a playback synchronization section 46, a synthesis control section 47, a playback permission section 48, a recording permission section 49, an operation information outputting section 50 and an electronic apparatus control section 51. It is to be noted that control lines from the control section 43 to the components of the communication apparatus 1-1 are omitted in FIG. 4.

The session management section 44 controls a process by the communication section 28 of establishing a connection to the communication apparatus 1-2, content supplying server 3, authentication server 4 or the like through the communication network 2. The viewing recording level setting section 45 sets, based on a setting operation from a user, whether or not real-time data of the user acquired by the inputting section 24 can be played back by the communication apparatus 1-2 of the communication opposite party, whether or not the real-time data can be recorded and, where the real-time data can be recorded, the number of times by which recording is permitted. Then, the viewing recording level setting section 45 issues a notification of the setting information from the communication section 28 to the communication apparatus 1-2. The playback synchronization section 46 controls the broadcast reception section 29 and the content playback section 30 so that the same content may be played back in synchronism with the communication apparatus 1-2 of the communication opposite party.

The synthesis control section 47 controls the image sound synthesis section 31 based on an analysis result of the image analysis section 35 and so forth so that an image and sound of a content and images and sound of users may be synthesized in accordance with a setting operation from the user. The playback permission section 48 decides based on license information and so forth added to a content whether or not playback of the content is permitted, and controls the content playback section 30 based on a result of the decision. The recording permission section 49 decides based on setting of the communication opposite party and license information added to a content whether or not recording of real-time data of the users and the content is permitted, and controls the storage section 32 based on a result of the decision. The operation information outputting section 50 produces, in response to an operation by a user (a channel changeover operation upon reception of a television broadcast, or an operation for starting of playback, ending of playback, fast feeding playback or the like), operation information (whose details are hereinafter described) including the substance of the operation, the time of the operation and so forth. Then, the operation information outputting section 50 issues a notification of the operation information from the communication section 28 to the communication apparatus 1-2 of the communication opposite party. The operation information is utilized for synchronous playback of the content.

The electronic apparatus control section 51 controls a predetermined electronic apparatus (for example, a lighting fixture, an air conditioner, or the like; all not shown) connected (including radio connection) to the communication apparatus 1-1 based on motion vector matching information inputted from the image analysis section 35.

It is to be noted that an example of a detailed configuration of the communication apparatus 1-2 is similar to that of the communication apparatus 1-1 shown in FIG. 4, and therefore, description of the same is omitted herein.

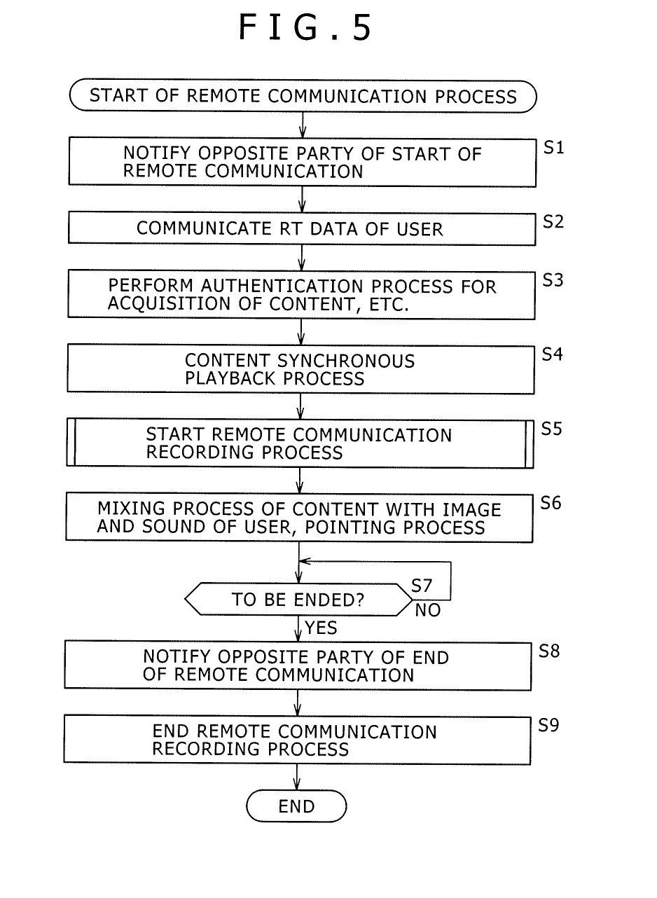

Now, a remote communication process with the communication apparatus 1-2 by the communication apparatus 1-1 is described with reference to a flow chart of FIG. 5.

This remote communication process is started when an operation to instruct starting of remote communication with the communication apparatus 1-2 is inputted to the operation inputting section 42 and an operation signal corresponding to the operation is inputted to the control section 43.

At step S1, the communication section 28 establishes a connection to the communication apparatus 1-2 through the communication network 2 under the control of the session management section 44 and notifies the communication apparatus 1-2 of starting of remote communication. In response to the notification, the communication apparatus 1-2 returns acceptance of starting of remote communication.

At step S2, the communication section 28 begins to transmit real-time data of the user A and so forth inputted from the inputting section 24 to the communication apparatus 1-2 through the communication network 2 and starts reception of real-time data of the user X transmitted from the communication apparatus 1-2 under the control of the control section 43. Images and sound included in the transmitted real-time data of the user A and so forth and an image and sound included in the received real-time data of the user X are inputted to the storage section 32 and the image sound synthesis section 31.

At step S3, the communication section 28 establishes a connection to the authentication server 4 through the communication network 2 and performs an authentication process for acquisition of a content under the control of the session management section 44. After this authentication process, the communication section 28 accesses the content supplying server 3 through the communication network 2 to acquire a content designated by the user. It is assumed that, at this time, a similar process is executed also on the communication apparatus 1-2 and the same content is acquired.

It is to be noted that, where a content being broadcast as a television broadcast is to be received or where a content acquired already and stored in the storage section 32 is to be played back, the process at step S3 can be omitted.

At step S4, the content playback section 30 starts a playback process of the content synchronized with the communication apparatus 1-2 (such playback process is hereinafter referred to as content synchronous playback process) under the control of the playback synchronization section 46. Details of this content synchronous playback process are hereinafter described.

At step S5, the storage section 32 starts a remote communication recording process. In particular, recording of the content whose playback is started, images and sound included in the transmitted real-time data of the user A and so forth, an image and sound included in the received real-time data of the user X and the synthesis information 34 produced by the synthesis control section 47 and representative of synthesis of the images and sound mentioned is started.

At step S6, the image sound synthesis section 31 synthesizes an image and sound of the played back content, images and sound included in the transmitted real-time data of the user A and so forth and an image and sound included in the received real-time data of the user X, and supplies an image signal and a sound signal obtained as a result of the synthesis to the outputting section 21 under the control of the synthesis control section 47. The outputting section 21 displays an image corresponding to the image signal supplied thereto and outputs sound corresponding to the sound signal. At this stage, communication of images and sound between the users and synchronous playback of the content are started.

At step S6, in parallel to the processes of the image sound synthesis section 31 and so forth, the pointer detection section 37 of the image analysis section 35 executes a process (pointing process) of detecting the pointer of the user A and so forth based on the images included in the real-time data of the user A and so forth, displaying the pointers on the screen and so forth.

At step S7, the control section 43 decides whether or not an operation of issuing an instruction to end the remote communication is performed by the user, and waits that it is decided that the operation is performed. When it is decided that an operation of issuing an instruction to end the remote communication is performed by the user, the processing advances to step S8.

At step S8, the communication section 28 establishes a connection to the communication apparatus 1-2 through the communication network 2 and issues a notification to end the remote communication to the communication apparatus 1-2 under the control of the session management section 44. In response to the notification, the communication apparatus 1-2 returns acceptance of ending of the remote communication.

At step S9, the storage section 32 ends the communication recording process. The played back content, images and sound included in the real time data of the user A and so forth, image and sound included in the received real-time data of the user X and the synthesis information 34, which have been recorded till then, are utilized later when the present remote communication is reproduced.

The description of the remote communication process by the communication apparatus 1-1 is completed therewith.

Now, the content synchronous playback process at step S4 of the remote communication process described above is described.

For the content synchronous playback by the communication apparatus 1-1, three modes are available including a synchronous content acquisition mode applied to a first synchronous playback process, a following type synchronous mode applied to a second synchronous playback process and a reservation type synchronous mode applied to a third synchronous playback process.

The synchronous content acquisition mode is applied to a content which can be acquired by the communication apparatus 1-1 and the communication apparatus 1-2 in synchronism with each other and does not allow alteration of the playback timing or the like, more particularly to a case wherein a content of a program of a television broadcast or the like is received and viewed on the real time basis. In the case of a program of a television broadcast, only if the channels to be receives are same, also at remote places, the output timings of an image and sound coincide with each other. Accordingly, in the synchronous content acquisition mode, information representative of the channel of a television broadcast to be received is transmitted as operation information from the communication apparatus 1-1 to the communication apparatus 1-2.

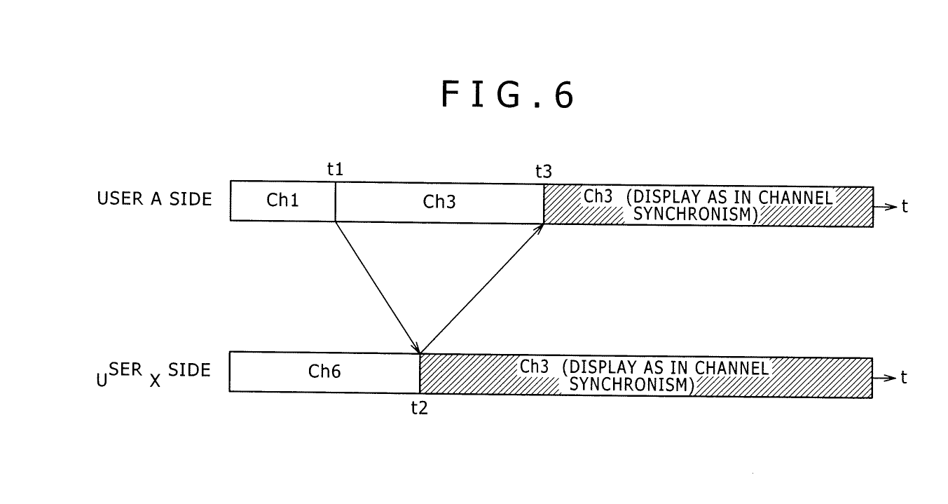

FIG. 6 illustrates an outline of action in the synchronous content acquisition mode. For example, if the channel of the communication apparatus 1-1 is changed over from a channel Ch1 to another channel Ch3 at time t1 by the user, then operation information representing that the channel is changed over to the channel Ch3 is produced and transmitted to the communication apparatus 1-2.

The communication apparatus 1-2 which receives the operation information from the communication apparatus 1-1 at time t2 changes over the channel to be received to the channel Ch3 and produces operation information representing that the channel is changed over to the channel Ch3. The operation information is sent back to the communication apparatus 1-1. Then, a notification that the content is played back in synchronism with the communication apparatus 1-1 is conveyed to the user (for example, a character string “in channel synchronism” is displayed in an overlapping relationship on the screen).

The communication apparatus 1-1 which receives the operation information from the communication apparatus 1-2 at time t3 issues a notification that the content is played back in synchronism with the communication apparatus 1-2 to the user A (for example, a character string “in channel synchronism” is displayed in an overlapping relationship on the screen).

As can be seen apparently also from FIG. 6, in the synchronous content acquisition mode, synchronous playback of a content (a program being broadcast) can be performed between the communication apparatus 1-1 and the communication apparatus 1-2 although a delay by time (t1-t2) required for communication of operation information is involved before synchronism of playback of the content is established after the user A performs a channel changeover operation.

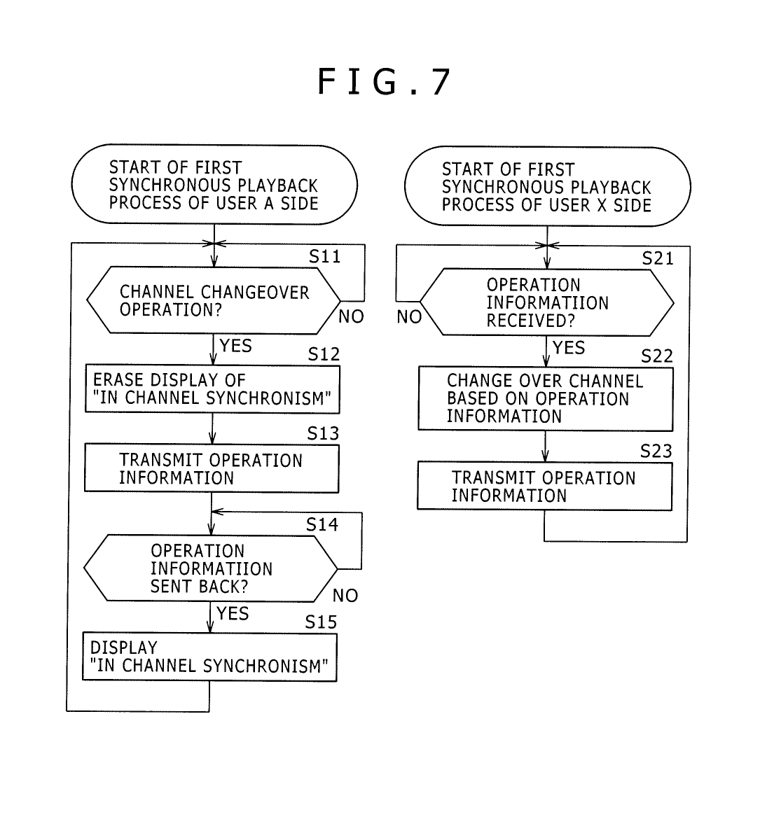

Now, action of the communication apparatus 1-1 and the communication apparatus 1-2 which execute the first synchronous playback process which adopts the synchronous content acquisition mode is described with reference to a flow chart of FIG. 7. It is to be noted that, in FIG. 7, steps S11 to S15 represent processes executed by the communication apparatus 1-1, and steps S21 to S23 represent processes executed by the communication apparatus 1-2. Further, it is assumed that the communication apparatus 1-1 and the communication apparatus 1-2 have already received a program (content) of a television broadcast and started playback of the program.

First, action of the communication apparatus 1-1 is described. At step S11, the control section 43 decides whether or not a channel changeover operation is performed for the operation inputting section 42 by the user, and waits that it is decided that a channel changeover operation is performed. Then, if it is decided that a channel changeover operation is performed for the operation inputting section 42 by the user, then the processing advances to step S12. At step S12, the playback synchronization section 46 controls the image sound synthesis section 31 to end, if a notification that synchronous playback of a content with the communication apparatus 1-2 is currently proceeding has been conveyed to the user, the notification (for example, if the character string “in channel synchronism” is displayed in an overlapping relationship on the screen, then the overlapping display is stopped).

At step S13, the operation information outputting section 50 produces operation information indicative of a channel after the changeover and controls the communication section 28 to transmit the operation information to the communication apparatus 1-2 through the communication network 2. At step S14, the playback synchronization section 46 decides whether or not operation information corresponding to the operation information transmitted to the communication apparatus 1-2 by the process at step S13 is sent back from the communication apparatus 1-2. In particular, the playback synchronization section 46 decides whether or not operation information indicating a channel same as the channel indicated by the operation information transmitted to the communication apparatus 1-2 by the process at step S13 is sent back from the communication apparatus 1-2. Then, the playback synchronization section 46 waits that it is decided that corresponding operation information is sent back. If it is decided that corresponding operation information is sent back, then the processing advances to step S15.

At step S15, the playback synchronization section 46 controls the image sound synthesis section 31 to issue a notification that synchronous playback of a content is proceeding with the communication apparatus 1-2 to the user (for example, causes the character string “in channel synchronism” to be displayed in an overlapping relationship on the screen). Thereafter, the processing returns to step S11, at which the control section 43 waits that a channel changeover operation is performed subsequently by the user.

Now, action of the other communication apparatus 1-2 is described. At step S21, the playback synchronization section 46 of the communication apparatus 1-2 decides whether or not operation information transmitted from the communication apparatus 1-1 is received, and waits that it is decided that such operation information is received. If it is decided that operation information transmitted from the communication apparatus 1-1 is received, then the processing advances to step S22. At step S22, the playback synchronization section 46 controls the broadcast reception section 29 to change over the channel of the television broadcast being received to the channel indicated by the operation information received at step S21. The playback synchronization section 46 of the communication apparatus 1-2 controls the image sound synthesis section 31 to issue a notification that synchronous playback of a content is proceeding with the communication apparatus 1-1 to the user (for example, causes “in channel synchronism” to be displayed on the screen).

At step S23, the operation information outputting section 50 of the communication apparatus 1-2 produces operation information representative of a channel after changeover and controls the communication section 28 to send back the operation information to the communication apparatus 1-1 through the communication network 2. Thereafter, the processing returns to step S21, at which the playback synchronization section 46 waits that operation information is received from the communication apparatus 1-1 subsequently.

As described above, with the first synchronous playback process which adopts the synchronous content acquisition mode, synchronous playback of a content (a program being broadcast) is possible between the communication apparatus 1-1 and the communication apparatus 1-2 although there is a delay by a period of time required for communication of operation information until synchronism is established after the user A performs a channel changeover operation.

It is to be noted that, while the foregoing description relates only to a case wherein the communication apparatus 1-2 follows the communication apparatus 1-1 (the communication apparatus 1-2 is synchronized with the communication apparatus 1-1), it is possible to reverse the master-slave relationship or change the relationship at any time.

Now, the following type synchronous mode applied to the second synchronous playback process is described. The following type synchronous mode is applied to a case wherein a content whose operation for playback starting, fast feeding playback, playback ending or the like can be instructed at an arbitrary timing by the user, different from a program of a television broadcast or the like, and which is acquired already by the communication apparatus 1-1 and the communication apparatus 1-2 in advance is played back. In the following type synchronous mode, if an operation for playback starting, fast feeding playback, playback ending or the like of a content is performed, then the substance of the operation and the operation time as well as information representative of the playback position of the content when the operation is performed is transmitted as operation information from the communication apparatus 1-1 to the communication apparatus 1-2.

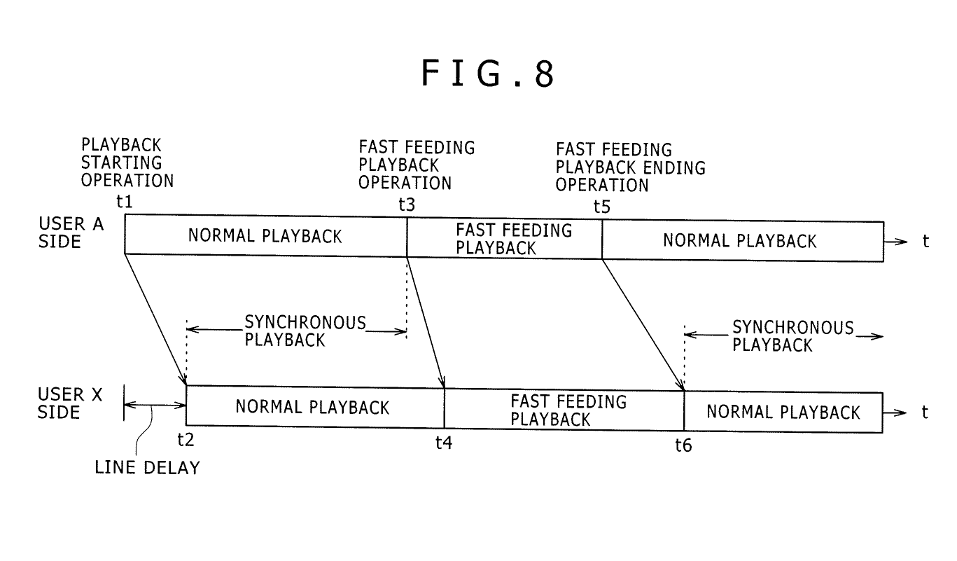

FIG. 8 illustrates an outline of action in the following type synchronous mode. For example, if an operation for playback starting of a content is performed at time t1 for the communication apparatus 1-1 by the user A, then playback of the content is started, and operation information representing that an operation for playback starting is performed and further representing time t1 of the operation and a playback position of the content at time t1 is produced. The operation information is transmitted to the communication apparatus 1-2 and is received by the communication apparatus 1-2 at time t2 because of a line delay of the communication network 2. The communication apparatus 1-2 starts playback of the content from a position advanced by time t2-t1 from the playback position of the content at time t1 based on the received operation information. Accordingly, after time t2, a state wherein the content is played back in synchronism continues. It is to be noted that, while the synchronous playback is proceeding, a notification that synchronous playback is proceeding may be issued to the user similarly as in the synchronous content acquisition mode described hereinabove (for example, “in channel synchronism” is displayed on the screen).

Further for example, if an operation for fast feeding playback of a content is performed at time t3 for the communication apparatus 1-1 by the user A, then the playback of the content is changed from normal playback to fast feeding playback, and operation information representing that an operation for fast feeding playback is performed and further representing the time t3 of the operation and a playback position of the content at time t3 is produced. The operation information is transmitted to the communication apparatus 1-2, and the communication apparatus 1-2 starts fast feeding playback of the content based on the received operation information. Accordingly, after time t3, a state wherein synchronism playback of the content is not performed continues.

Furthermore, if an operation for ending of fast feeding playback of the content (re-starting of normal playback) is performed at time t5 for the communication apparatus 1-1 by the user A, then normal playback of the content is re-started. Further, operation information representing that an operation for re-starting of normal playback is performed and also representing time t5 of the operation and the elapsed time of the content at time t5 is produced. The operation information is transmitted to the communication apparatus 1-2 and is received by the communication apparatus 1-2 at time t6 because of a line delay of the communication network 2. The communication apparatus 1-2 starts playback of the content from the position advanced by time (t6-t5) from the playback position of the content at time t5 based on the received operation information. Accordingly, after time t6, a state wherein synchronous playback of the content is performed continues.

Accordingly, in the following type synchronous mode, although time corresponding to a line delay required for communication of operation information is required until synchronism is established after the user A performs an operation for playback starting or the like, synchronous playback of a content between the communication apparatus 1-1 and the communication apparatus 1-2 is possible. However, there remains a problem that, in the following type synchronous mode, when the user A performs an operation for stopping playback of a content, the content proceeds by time corresponding to the line delay. This problem is solved by the reservation time synchronous mode hereinafter described.

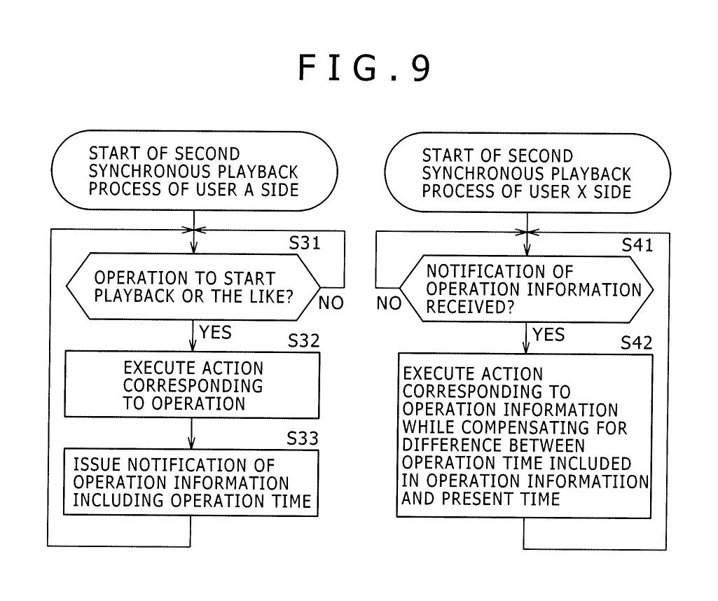

Now, action of the communication apparatus 1-1 and the communication apparatus 1-2 which execute the second synchronism playback process which adopts the following type synchronous mode is described with reference to a flow chart of FIG. 9. It is to be noted that, in FIG. 9, steps S31 to S33 represent processes executed by the communication apparatus 1-1 and steps S41 and S42 represent processes executed by the communication apparatus 1-2. It is assumed that the communication apparatus 1-1 and the communication apparatus 1-2 acquire the same content already.

First, action of the communication apparatus 1-1 is described. At step S31, the control section 43 decides whether or not an operation for playback starting of a content or the like is performed for the operation inputting section 42 by the user, and waits that it is decided that an operation for playback starting or the like is performed. Then, if it is decided that an operation for playback starting of a content or the like is performed for the operation inputting section 42 by the user, then the processing advances to step S32. At step S32, the playback synchronization section 46 executes a process corresponding to the operation of the user (for example, starts normal playback of the content).

At step S33, the operation information outputting section 50 produces information representative of the substance of the operation and operation information representative of the time at which the operation is performed and the playback position of the content at the operation time. Further, the operation information outputting section 50 controls the communication section 28 to transmit the produced information to the communication apparatus 1-2 through the communication network 2. Thereafter, the processing returns to step S31, at which the control section 43 waits that an operation for playback ending or the like is performed subsequently.

Now, action of the other communication apparatus 1-2 is described. At step S41, the playback synchronization section 46 of the communication apparatus 1-2 decides whether or not operation information transmitted from the communication apparatus 1-1 is received, and waits that it is decided that operation information is received. If it is decided that operation information transmitted from the communication apparatus 1-1 is received, then the processing advances to step S42. At step S42, the playback synchronization section 46 advances the playback position of the content included in the received operation information by an amount equal to the difference between the operation time and the time at present. Further, the playback synchronization section 46 controls the content playback section 30 to execute a process corresponding to the operation information (for example, controls the content playback section 30 to start normal playback of the content). Thereafter, the processing returns to step S41, at which the playback synchronization section 46 waits that operation information from the communication apparatus 1-1 is received subsequently.

It is to be noted that, also in the following type synchronous mode, while synchronism playback of a content is being performed, a notification that synchronism playback is being performed (for example, “in channel synchronism” may be displayed on the screen) may be conveyed to the user as in the synchronous content acquisition mode described above.

As described above, with the second synchronous playback process which adopts the following type synchronous mode, although the timing of starting or ending of playback of a content is displaced, after playback is started, the playback positions of the content by the communication apparatus 1-1 and the communication apparatus 1-2 can be made coincide with each other.

It is to be noted that, while the foregoing description relates only to a case wherein the communication apparatus 1-2 follows the communication apparatus 1-1 (the communication apparatus 1-2 is synchronized with the communication apparatus 1-1), it is possible to reverse the master-slave relationship or change the relationship at any time.

Now, the reservation time synchronous mode applied to the third synchronous playback process is described. The reservation time synchronous mode is applied to a case wherein a content whose operation for playback starting, fast feeding playback, playback ending or the like can be instructed at an arbitrary timing by the user, different from a program of a television broadcast or the like, and which is acquired already by the communication apparatus 1-1 and the communication apparatus 1-2 in advance is played back. A relationship to the following type synchronous mode is hereinafter described.

In the reservation time synchronous mode, if an operation for playback starting, fast feeding playback, playback ending or the like of a content is performed, then information representative of the substance of the operation, execution scheduled time of a process corresponding to the operation and the playback position of the content when the operation is performed is transmitted as operation information from the communication apparatus 1-1 to the communication apparatus 1-2.

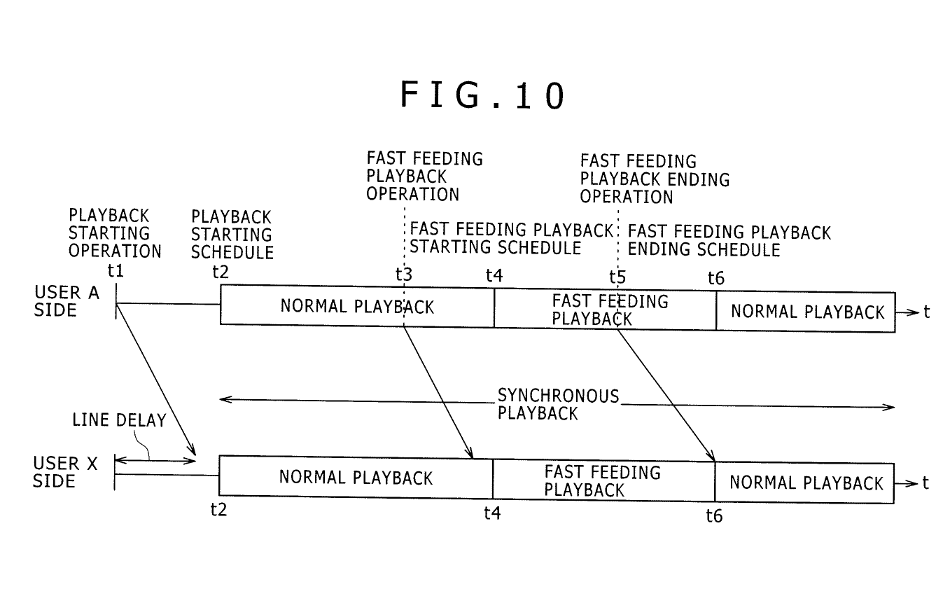

FIG. 10 illustrates an outline of action of the scheduled type synchronous mode. For example, if an operation for playback starting of a content is performed at time t1 for the communication apparatus 1-1 by the user A, then a circuit delay when operation information is transmitted to the communication apparatus 1-2 is taken into consideration to determine reproduction starting scheduled time t2. Further, operation information representing that an operation for playback starting and also representing the reproduction starting scheduled time t2 and the playback position of the content at time t2 is produced and transmitted to the communication apparatus 1-2. Then, the communication apparatus 1-1 starts playback of the content at time t2. Also the communication apparatus 1-2 which receives the operation information from the communication apparatus 1-1 starts, when the reproduction starting scheduled time t2 represented by the received operation information comes, playback of the content from the playback position of the content represented by the received operation information. Accordingly, after time t2, a state wherein synchronous playback of the content is performed continues.

It is to be noted that the reproduction starting scheduled time t2 is determined, for example, by adding predetermined time (several seconds) to a mean value of the line delay time detected periodically by the communication environment detection section 40. Or, the reproduction starting scheduled time t2 may be determined merely by adding predetermined time (several seconds) to time t1 at which the operation is performed.

Further, for example, if an operation for fast feeding playback of a content is performed at time t3 for the communication apparatus 1-1 by the user A, then the line delay when operation information is transmitted to the communication apparatus 1-2 is taken into consideration to determine fast feeding playback starting scheduled time t4. Then, operation information representing that an operation for fast feeding playback is performed and also representing the fast feeding playback starting scheduled time t4 and the fast feeding playback position of the content at time t4 is produced and transmitted to the communication apparatus 1-2. Then, the communication apparatus 1-1 starts fast feeding playback of the content when the time t4 comes. Also in the communication apparatus 1-2 which receives the operation information from the communication apparatus 1-1, fast feeding playback of the content is started when the fast feeding playback starting scheduled time t4 represented by the received operation information comes. Accordingly, also upon fast feeding playback later than time t4, a state wherein synchronism of the content is maintained continues.

In this manner, in the reservation time synchronous mode, when an operation for playback starting or the like is performed by the user A, the line delay time of the communication network 2 is taken into consideration to determine starting scheduled time of a process corresponding to the operation. Then, when the scheduled time comes, action corresponding to the operation is started. Therefore, after time t2, synchronous playback of the content between the communication apparatus 1-1 and the communication apparatus 1-2 is possible.

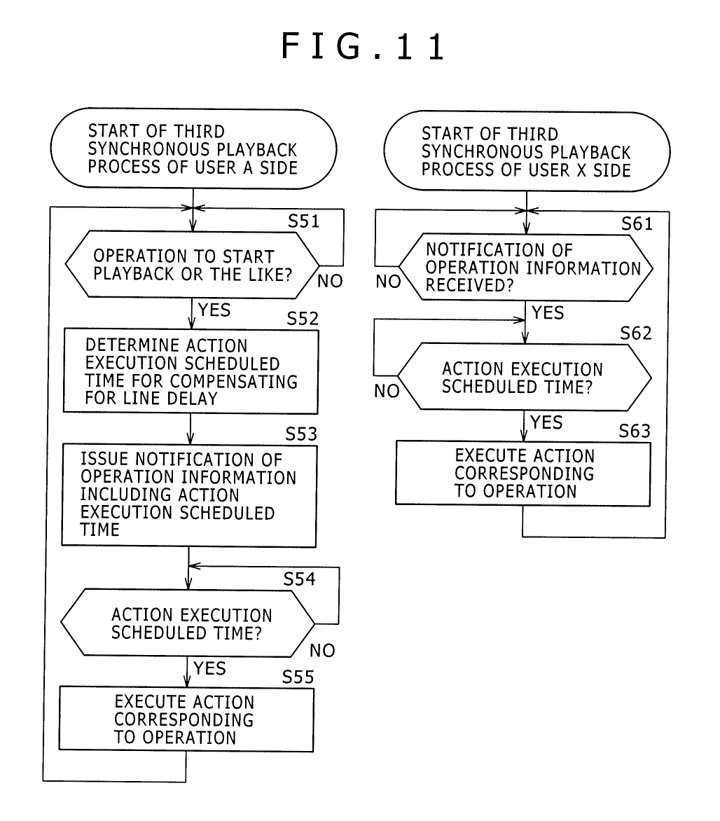

Now, action of the communication apparatus 1-1 and the communication apparatus 1-2 which execute the third synchronous playback process which adopts the reservation time synchronous mode is described with reference to a flow chart of FIG. 11. It is to be noted that, in FIG. 11, steps S51 to S55 represent processes executed by the communication apparatus 1-1 and steps S61 to S63 represent processes executed by the communication apparatus 1-2. Further, it is assumed that the communication apparatus 1-1 and the communication apparatus 1-2 already acquire the same content.

First, action of the communication apparatus 1-1 is described. At step S51, the control section 43 decides whether or not an operation for playback starting of a content or the like is performed for the operation inputting section 42 by the user, and waits that it is decided that an operation for playback starting or the like is performed. Then, if it is decided that an operation for playback starting or the like is performed for the operation inputting section 42 by the user, then the processing advances to step S52.

At step S52, the playback synchronization section 46 adds an average value of the line delay time of the communication network 2, which is periodically detected by the communication environment detection section 40, and predetermined time (several seconds) to the time at present to determine operation execution scheduled time. At step S53, the operation information outputting section 50 produces information representative of the substance of the operation and operation information representative of action execution scheduled time corresponding to the operation and the playback position of the content at the action execution scheduled time. Further, the operation information outputting section 50 controls the communication section 28 to transmit the produced information to the communication apparatus 1-2 through the communication network 2.

At step S54, the playback synchronization section 46 waits that the standard time supplied from the standard time counting section 41 coincides with the action execution scheduled time. If the standard time supplied from the standard time counting section 41 coincides with the action execution scheduled time, then the processing advances to step S55. At step S55, the playback synchronization section 46 executes a process corresponding to the operation from the user (for example, starts normal playback of the content). Thereafter, the processing returns to step S51, at which the playback synchronization section 46 waits that an operation for playback ending or the like is performed subsequently.

Now, action of the other communication apparatus 1-2 is described. At step S61, the playback synchronization section 46 of the communication apparatus 1-2 decides whether or not operation information transmitted from the communication apparatus 1-1 is received, and waits that it is decided that operation information is received. If it is decided that operation information transmitted from the communication apparatus 1-1 is received, then the processing advances to step S62. At step S62, the playback synchronization section 46 waits that the standard time supplied from the standard time counting section 41 coincides with the action execution scheduled time included in the received operation information. If the standard time supplied from the standard time counting section 41 coincides with the action execution scheduled time, then the processing advances to step S63. At step S63, the playback synchronization section 46 executes a process corresponding to the operation substance included in the received operation information from the playback position of the content included in the received operation information (for example, starts normal playback of the content). Thereafter, the processing returns to step S61, at which the playback synchronization section 46 waits that operation information is received from the communication apparatus 1-1 subsequently.

As described above, with the third synchronous playback process which adopts the reservation time synchronous mode, if an operation for playback starting or the like is performed by the user A, then the line delay time of the communication network 2 is taken into consideration to determine starting scheduled time of a process corresponding to the operation. Then, when the scheduled time comes, action corresponding to the operation is started simultaneously by the communication apparatus 1-1 and the communication apparatus 1-2. Therefore, synchronous playback of a content can always be performed by the communication apparatus 1-1 and the communication apparatus 1-2.

However, if the communication situation of the communication network 2 or the like is so unstable that the line delay time varies by a great amount, then it cannot be avoided to set an increased time difference between the time at which an operation is performed and starting scheduled time of a process corresponding to the operation. However, the state wherein, even if an operation is performed, corresponding action does not start soon is inferior in operability to a user of the communication apparatus 1-1 and makes the user feel stress.

Accordingly, only when the communication situation of the communication network 2 is stable and the line delay time remains within a predetermined range, the third synchronous playback process to which the reservation time synchronous mode is applied is executed. However, when the line delay time of the communication network 2 is unstable, the second synchronous playback process to which the following type synchronous mode is applied is executed. It is to be noted that the determination of which one of the third synchronous playback process to which the reservation time synchronous mode is applied and the second synchronous playback process to which the following type synchronous mode is applied should be executed may be made by one of the communication apparatus 1-1 and the communication apparatus 1-2. Or, the determination may be made by a predetermined server connected to the communication network 2.

Further, while the foregoing description relates only to a case wherein the communication apparatus 1-2 follows the communication apparatus 1-1 (the communication apparatus 1-2 is synchronized with the communication apparatus 1-1), it is possible to reverse the master-slave relationship or change the relationship at any time.

Further, while the foregoing description mentions only a case wherein a single communication apparatus 1 (communication apparatus 1-2) follows the communication apparatus 1-1, a plurality of communication apparatus 1 may follow the communication apparatus 1-1. Further, a plurality of communication apparatus 1 may reverse the master-slave relationship or change the relationship thereof at any time.

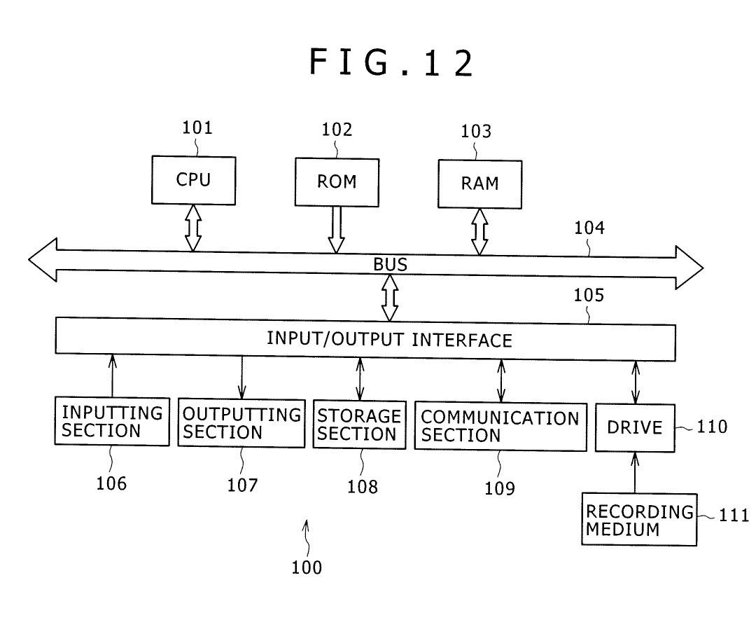

Incidentally, while the processes by the communication apparatus 1-1 described above can be executed by hardware, they may otherwise be executed by software. Where the series of processes is executed by software, a program which constructs the software is installed from a program recording medium into a computer incorporated in hardware for exclusive use or, for example, such a general purpose personal computer as shown in FIG. 12 which can execute various functions by installing various programs.

The personal computer 100 includes a built-in CPU (Central Processing Unit) 101. An input/output interface 105 is connected to the CPU 101 through a bus 104. A ROM (Read Only Memory) 102 and a RAM (Random Access Memory) 103 are connected to the bus 104.

An inputting section 106 including inputting devices such as a keyboard, a mouse and so forth for being operated by a user to input an operation command an outputting section 107 for displaying an image and outputting sound, a storage section 108 formed from a hard disk drive or the like for storing a program, various data and so forth and a communication section 109 for executing a communication process through a network represented by the Internet are connected to the input/output interface 105. Further, a drive 110 which reads and writes data from and on a recording medium 111 such as a magnetic disk (including a flexible disk), an optical disk (including a CD-ROM (Compact Disc-Read Only Memory) and a DVD (Digital Versatile Disc)), a magneto-optical disk (including an MD (Mini Disc)), or a semiconductor memory is connected to the input/output interface 105.

The program for causing the personal computer 100 to execute the processes of the communication apparatus 1 described hereinabove is supplied in a state wherein it is stored in the recording medium 111 to the personal computer 100. Then, the program is read out by the drive 110 and installed into the hard disk drive built in the storage section 108. The program installed in the storage section 108 is loaded into the RAM 103 from the storage section 108 in accordance with an instruction of the CPU 101 corresponding to a command from the user inputted to the inputting section 106. Then, the program loaded in the RAM 103 is executed.

It is to be noted that, in the present specification, the steps which are executed based on the program include not only processes which are executed in a time series in the order as described but also processes which may be but need not necessarily be processed in a time series but may be executed in parallel or individually without being processed in a time series.

The program may be processed by a single computer or may be processed discretely by a plurality of computers. Further, the program may be transferred to and executed by a computer at a remote place.

Further, in the present specification, the term system is used to represent an entire apparatus composed of a plurality of devices or apparatus.

1. An information processing apparatus which communicates with a different information processing apparatus through a network, comprising:
a playback section configured to play back content data in response to an operation by a user;
a production section configured to produce operation information corresponding to the operation by the user and transmit the operation information to the different information processing apparatus through said network; and
a playback control section configured to synthesize playback of the content data by said playback section with play back of the content data by the different information processing apparatus based on operation information transmitted from the different information processing apparatus through said network.

2. The information processing apparatus according to claim 1, wherein
the content data are data broadcast as a television program.

3. The information processing apparatus according to claim 2, wherein
said production section produces, in response to an operation of changing over the channel of the television broadcast by the user, the operation information representative of a channel after the changeover.

4. The information processing apparatus according to claim 1, wherein
said production section produces the operation information which includes at least one of the substance of the operation of the user, time at which the operation is performed and a playback position of the content data.

5. The information processing apparatus according to claim 1, wherein
said production section produces the operation information which includes at least one of the substance of the operation of the user, starting scheduled time of a process corresponding to the operation and a playback position of the content data.

6. The information processing apparatus according to claim 5, further comprising:
a detection section configured to detect communication time required for communication of the operation information through said network; and wherein
said production section determines the starting scheduled time of the process corresponding to the operation based on the communication time.

7. The information processing apparatus according to claim 1, further comprising:
a communication section configured to communicate sound and an image of the user with the different information processing apparatus through said network.

8. An information processing method for an information processing apparatus which communicates with a different information processing apparatus through a network, comprising the steps of:
playing back content data in response to an operation by a user;
producing operation information corresponding to the operation by the user and transmitting the operation information to the different information processing apparatus through the network; and
synthesizing playback of the content data by the process at the playback step with play back of the content data by the different information processing apparatus based on operation information transmitted from the different information processing apparatus through the network.

9. A recording medium on which a computer-readable program for allowing an information processing apparatus to communicate with a different information processing apparatus through a network is recorded, the program comprising the steps of:
playing back content data in response to an operation by a user;
producing operation information corresponding to the operation by the user and transmitting the operation information to the different information processing apparatus through the network; and
synthesizing playback of the content data by the process at the playback step with play back of the content data by the different information processing apparatus based on operation information transmitted from the different information processing apparatus through the network.

10. A program for allowing an information processing apparatus to communicate with a different information processing apparatus through a network, comprising the steps of:
playing back content data in response to an operation by a user;
producing operation information corresponding to the operation by the user and transmitting the operation information to the different information processing apparatus through the network; and
synthesizing playback of the content data by the process at the playback step with play back of the content data by the different information processing apparatus based on operation information transmitted from the different information processing apparatus through the network.
